(19) United States
(12) Patent Application Publication
(10) Pub. No.: US 2023/0134355 A1
(43) Pub. Date: May 4, 2023

(54) Efficient Processing For Artificial Reality

(71) Applicant: Meta Platforms Technologies, LLC, Menlo Park, CA (US)

(72) Inventors: Steven Paul Lansel, Apopka, FL (US); Todd Douglas Keeler, Magrath (CA); Rohit Rao Padebettu, San Mateo, CA (US); Alexander Michael Louie, Milpitas, CA (US); Michal Hlavac, Seattle, WA (US); Wai Leong Chak, Bellevue, WA (US); Yeliz Karadayi, Seattle, WA (US)

(21) Appl. No.: 17/974,826

(22) Filed: Oct. 27, 2022

Related U.S. Application Data
(60) Provisional application No. 63/273,588, filed on Oct. 29, 2021.
(60) Provisional application No. 63/297,919, filed on Jan. 10, 2022.

(51) Int. Cl. G06T 11/00; G06T 3/00; G06T 1/60; G06F 9/54

(52) U.S. Cl. CPC G06T 11/00; G06T 3/0093; G06T 1/60; G06F 9/544; G06T 2200/16

(57) ABSTRACT

In one embodiment, a method includes accessing a first image corresponding to a first frame of a video stream, rendering a first area of a second image corresponding to a second frame of the video stream, generating a second area of the second image corresponding to the second frame of the video stream by re-projecting the second area of the first image according to one or more warping parameters, and constructing the second image corresponding to the second frame by compositing the rendered first area and the generated second area of the second image.

In another embodiment, a method includes an operating system receiving a set of data associated with an object from a first application, storing the set of data on the operating system, receiving a command to share the object with a second application, and allowing the second application to access the portion of the data associated with the object that it needs.

### PRIORITY

This application claims the benefit under 35 U.S.C. § 119(e) of U.S. Provisional Patent Application No. 63/273,588, filed 29 Oct. 2021, and U.S. Provisional Patent Application No. 63/297,919, filed 10 Jan. 2022, which are incorporated herein by reference.

### BRIEF DESCRIPTION OF THE DRAWINGS

FIG. 1A illustrates an example artificial reality system.

FIG. 1B illustrates an example augmented reality system.

FIG. 2 illustrates an example impact of hardware Multiview on an inset TFR.

FIG. 3 illustrates an example slice based TFR operation.

FIG. 4 illustrates an example of a combined motion vector calculation.

FIG. 5 illustrates an example of separated motion vector calculations.

FIG. 6 illustrates an example method for rendering a slice of a frame and filling the rest of the frame with reprojections from previous frames.

FIG. 7 illustrates an example method for sharing data between applications on an artificial-reality device.

FIG. 8 illustrates an example computer system.

FIG. 9 illustrates an example network environment connecting artificial-reality devices.

FIG. 10 illustrates an example social graph.

### DESCRIPTION OF EXAMPLE EMBODIMENTS

Particular embodiments described herein relate to systems and methods for achieving Graphics Processing Unit (GPU) savings by rendering a slice of a frame and filling the rest of the frame with reprojections from previous frames. Foveated rendering is a rendering technique to reduce the rendering workload by reducing the image quality in the peripheral vision. Foveated rendering may be performed spatially to reduce the rendered resolution or pixel density in the peripheral region of each frame. Slice-based Temporal Foveated Rendering (S-TFR) described herein is a method of achieving GPU savings by reducing rendering frequency in slices of the frames. S-TFR may be designed to overcome the limitation of hardware architecture on mobile GPUs.

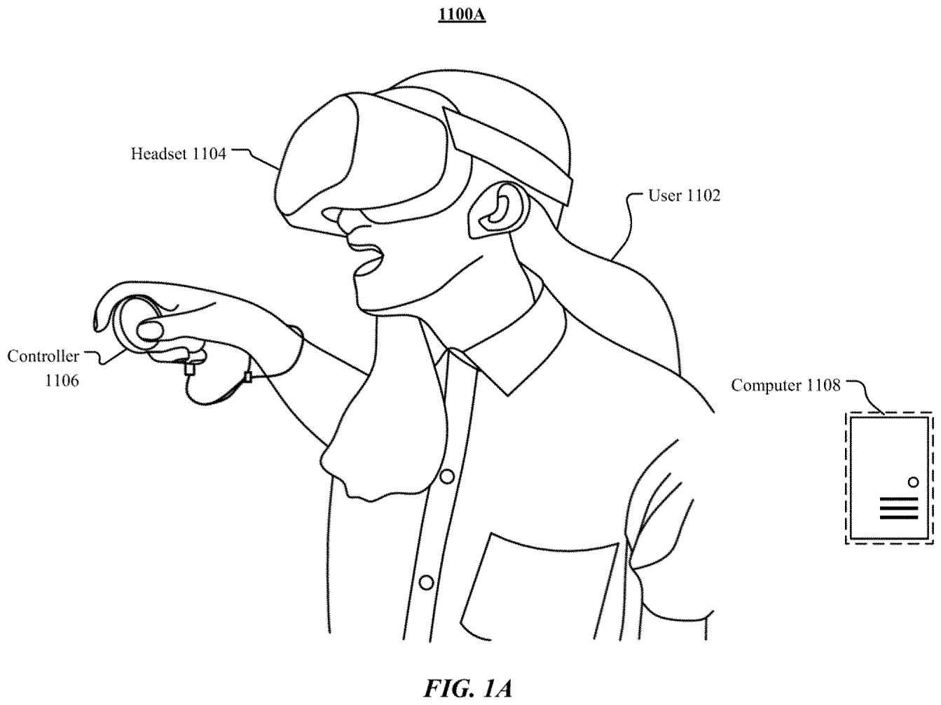

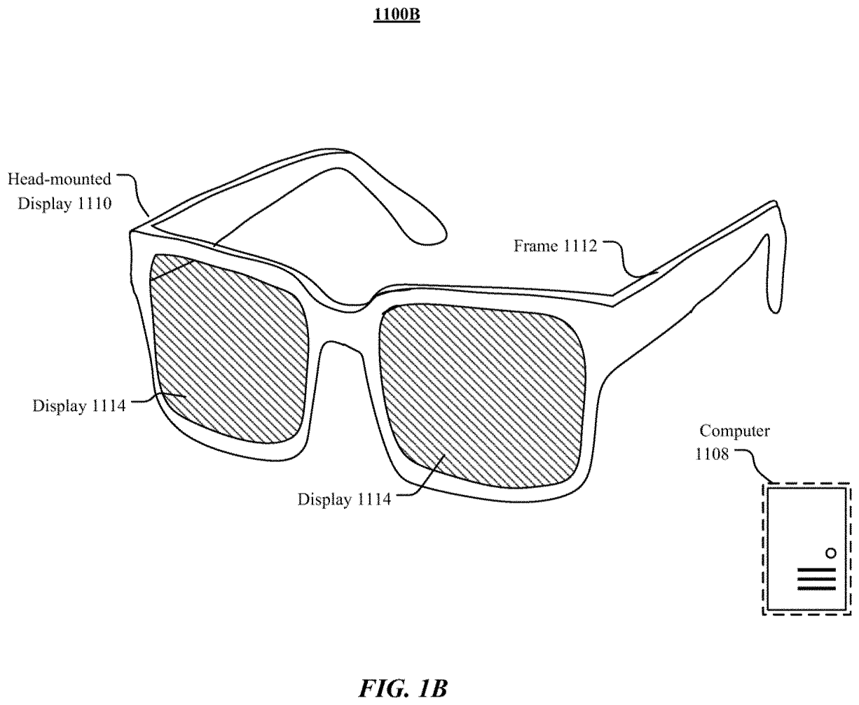

FIG. 1A illustrates an example artificial reality system 1100A. In particular embodiments, the artificial reality system 1100A may comprise a headset 1104, a controller 1106, and a computing device 1108. A user 1102 may wear the headset 1104 that may display visual artificial reality content to the user 1102. The headset 1104 may include an audio device that may provide audio artificial reality content to the user 1102. The headset 1104 may include one or more cameras which can capture images and videos of environments. The headset 1104 may include an eye tracking system to determine the vergence distance of the user 1102. The headset 1104 may include a microphone to capture voice input from the user 1102. The headset 1104 may be referred as a head-mounted display (HMD). The controller 1106 may comprise a trackpad and one or more buttons. The controller 1106 may receive inputs from the user 1102 and relay the inputs to the computing device 1108. The controller 1106 may also provide haptic feedback to the user 1102. The computing device 1108 may be connected to the headset 1104 and the controller 1106 through cables or wireless connections. The computing device 1108 may control the headset 1104 and the controller 1106 to provide the artificial reality content to and receive inputs from the user 1102. The computing device 1108 may be a standalone host computing device, an on-board computing device integrated with the headset 1104, a mobile device, or any other hardware platform capable of providing artificial reality content to and receiving inputs from the user 1102.

FIG. 1B illustrates an example augmented reality system 1100B. The augmented reality system 1100B may include a head-mounted display (HMD) 1110 (e.g., glasses) comprising a frame 1112, one or more displays 1114, and a computing device 1108. The displays 1114 may be transparent or translucent allowing a user wearing the HMD 1110 to look through the displays 1114 to see the real world and displaying visual artificial reality content to the user at the same time. The HMD 1110 may include an audio device that may provide audio artificial reality content to users. The HMD 1110 may include one or more cameras which can capture images and videos of environments. The HMD 1110 may include an eye tracking system to track the vergence movement of the user wearing the HMD 1110. The HMD 1110 may include a microphone to capture voice input from the user. The augmented reality system 1100B may further include a controller comprising a trackpad and one or more buttons. The controller may receive inputs from users and relay the inputs to the computing device 1108. The controller may also provide haptic feedback to users. The computing device 1108 may be connected to the HMD 1110 and the controller through cables or wireless connections. The computing device 1108 may control the HMD 1110 and the controller to provide the augmented reality content to and receive inputs from users. The computing device 1108 may be a standalone host computer device, an on-board computer device integrated with the HMD 1110, a mobile device, or any other hardware platform capable of providing artificial reality content to and receiving inputs from users.

Next generation HMD may have mobile, high resolution, high framerate displays. GPUs associated with the next generation HMD may be expected to be compute bound for the foreseeable future. As such, applications may need to employ rendering optimizations to maintain resolution/framerate. In the context of remote and cloud rendering, an application running on the HMD may render the frame in a remote server and streams the content onto a client. In such use-cases, the central server could be constrained by the number of factors such as number of clients, latency requirements, network shaping and load balancing etc. Similar to rendering on mobile HMDs, optimizations are required for rendering servers.

Examples of an inset TFR are disclosed in U.S. patent application Ser. No. 17/113,21228, entitled “Temporal Foveated Rendering” and filed 23 Dec. 12020, which is incorporated herein by reference as examples only and not by way of limitation. An inset TFR may involve rendering an inset region (typically rectangular) in the central Field of View (FoV) of each frame. This approach may be feasible but may not be compatible on some mobile GPUs due to a feature called hardware multiview. Hardware multiview is a GPU technique that reduces costs of stereo rendering by combining similar parts (tiles) of the 2 views at the same time. In mobile GPUs, the image may be divided into a grid of tiles that may be individually rendered. Each tile may be rendered with different properties (for example full resolution, reduced resolution, or turned off). In inset TFR, Insets may be rendered using a GPU feature called tile-turn off. An outset, an area outside of the inset region, may not be rendered by turning off the tiles corresponding to outset. For each eye, Inset TFR may alternate between inset images and full-frame images. To balance the rendering load over time, the left and right eye may be offset so at each point in time there is 1 inset frame and 1 full frame. Hardware multiview may incur significant cost and difficulty to render stereo views if the corresponding tiles in the left and right eye are not rendered with the same parameters. In other words, rendering an inset in only one eye may not offer significant GPU rendering savings. Hardware multiview may provide GPU savings only when tiles in both the eyes are turned off.

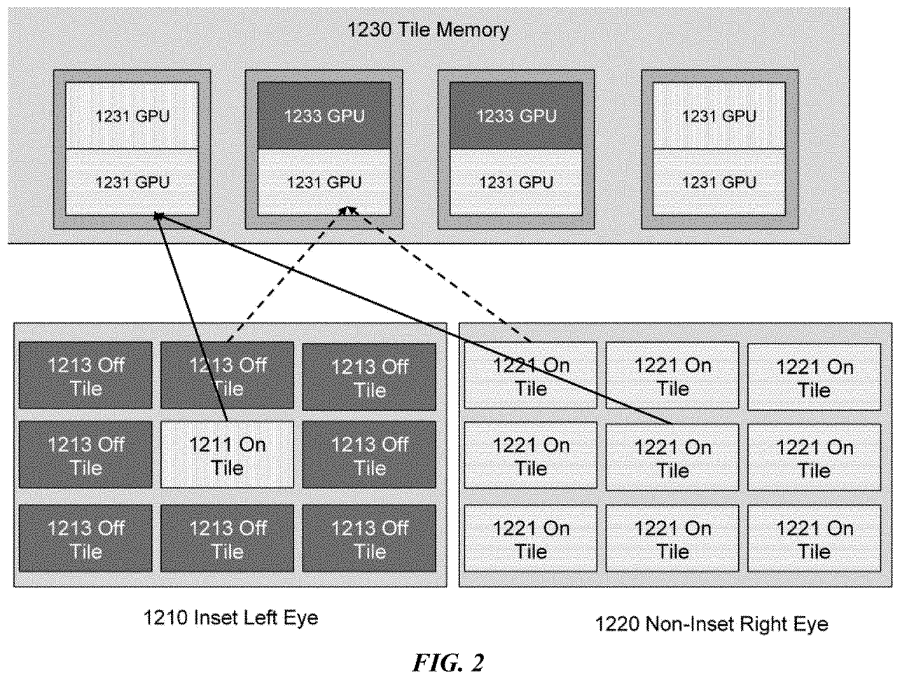

FIG. 2 illustrates an example impact of hardware multiview on an inset TFR. In the example illustrated in FIG. 2, a frame for left eye 1210 is being inset-rendered while a frame for right eye 1220 is being non-inset-rendered, i.e., fully rendered. For the left eye 1210, only tiles in the inset regions, indicated as on tiles 1211, are rendered while tiles in the outset regions, indicated off tiles 1213, are filled with reprojections from a previous frame. Because the right eye 1220 is being non-inset-rendered, all the tiles in the frame are on tiles 1221. However, when the tiles are processed by one or more GPUs on a tile memory 1230, the on tiles 1211 and 1221 may be processed by GPU units 1231. But, the off tiles 1213 may consume GPU units 1233 even though the off tiles 1213 are not supposed to be rendered due to the hardware multiview feature. Thus, GPU resource conservation by inset TFR becomes minimal if the GPUs are using the hardware multiview feature.

In particular embodiments, a computing system may overcome hardware architecture limitations by rendering a slice of a frame and filling the rest of the frame with reprojections from previous frames. The computing system may access a first image corresponding to a first frame of a video stream. The computing system may render a first area of a second image corresponding to a second frame of the video stream. The second frame may be subsequent to the first frame. The first area may be an incomplete part of the second image. The computing system may generate a second area of the second image corresponding to the second frame of the video stream by re-projecting the second area of the first image according to one or more warping parameters. The second area may be rest of the first area in the images. The computing system may construct the second image corresponding to the second frame by compositing the rendered first area and the generated second area of the second image. Although this disclosure describes slice-based TFR in a particular manner, this disclosure contemplates slice-based TFR in any suitable manner.

In particular embodiments, the novel rendering method for TFR may overcome limitations of hardware multiview. In this method, the computing system may alternatively turn off far right and far left regions of the screen. The computing system may fill the turned off regions with the previous frame reprojected with one or more warping parameters. Although this disclosure describes alternatively turning off regions of the screen in a particular manner, this disclosure contemplates alternatively turning off regions of the screen in any suitable manner.

In particular embodiments, the one or more warping parameters may comprise space warping parameters. The computing system may determine the space warping parameters based on motion vectors in the re-projected second area of the first image. The space warping parameters may be used to generate an extrapolated image corresponding to a frame from images corresponding to previous frames. The motion vectors may be determined based on images corresponding to previous frames. In particular embodiments, determining the motion vectors may be based on optical flow. To apply the space warping parameters, the computing device may distort the re-projected second area of the first image such that objects in motion in the re-projected area are re-positioned using the determined motion vectors. Although this disclosure describes applying space warping parameters in a particular manner, this disclosure contemplates applying space warping parameters in any suitable manner.

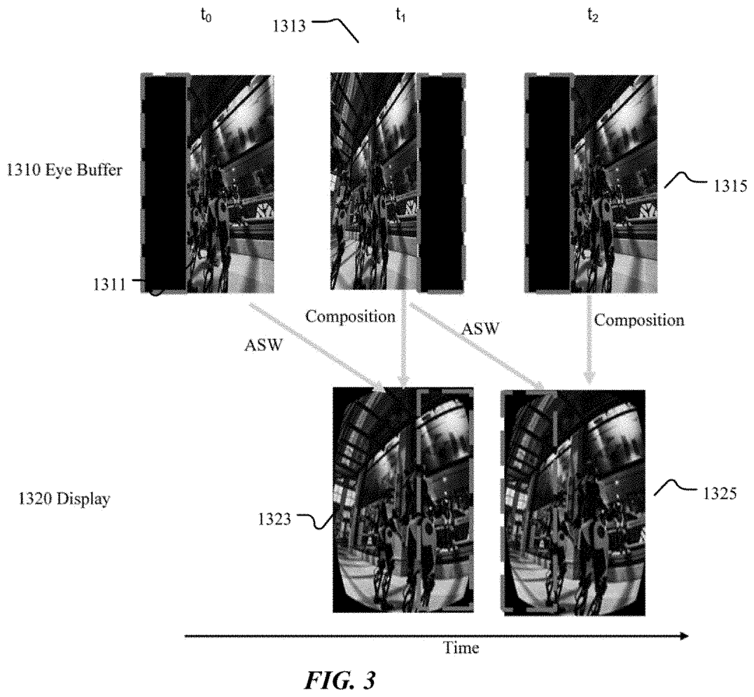

FIG. 3 illustrates an example slice based TFR operation. At time to, the computing system may render a part of the first image 1311 corresponding to a first frame of a video stream on an eye buffer 1310. When the part of the first image 1311 is rendered, the computing system may turn off tiles belonging to rest of the image, which is a left side of the image. At time t₁, the computing system may render a part of a second image 1313 corresponding to a second frame of the video stream on the eye buffer 1310. When the part of the second image 1313 is rendered, the computing system may turn off tiles belonging to a rest of the image, which is a right side of the image. The computing system may construct a second image 1323 on a display 1320 corresponding to the second frame of the video stream by compositing the rendered part of the second image 1313 and a re-projected area of the first image 1311 according to one or more warping parameters. The re-projected area of the first image 1311 may correspond to the rest of the rendered part of the second image 1313. At time t₂, the computing system may render a part of a third image 1315 corresponding to a third frame of the video stream on the eye buffer 1310. When the part of the third image 1315 is rendered, the computing system may turn off tiles belonging to a rest of the image, which is a left side of the image. The computing system may construct a third image 1325 on the display 1320 corresponding to the third frame of the video stream by compositing the rendered part of the third image 1315 and a re-projected area of the second image 1313 according to one or more warping parameters. The re-projected area of the second image 1313 may correspond to the rest of the rendered part of the third image 1315. Although this disclosure describes implementing a slice-based TFR in a particular manner, this disclosure contemplates implementing a slice-based TFR in any suitable manner.

In particular embodiments, a rendered frame may be viewed as a full-rate slice sandwiched with a couple of half-rate slices. Alternatively, top and bottom slices may also be turned off. The main idea is that slices cover the edges in both the eyes. This rendering method may be compatible with hardware multiview as tiles corresponding to both the eyes may be turned off synchronously. Using Slice TFR may achieve up-to 21% reduction in rendering time.

In particular embodiments, larger half-rate slices may introduce visual artifacts at the cost of additional compute saving. The computing system may provide options to vary the size of half-rate slices. The provided options may allow developers to trade off quality for GPU gain/saving.

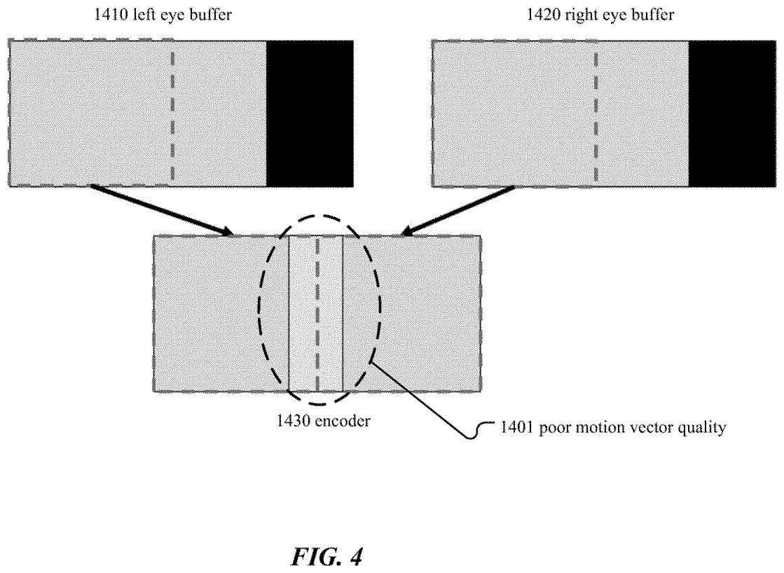

Asynchronous Spacewarp (ASW) is a technique to reproject previous frames using motion vectors that describe where regions of the scene are moving over time. The motion vectors may be generated a number of ways including using a video encoder for block matching and calculating optical flow. Frame slicing may require ASW to run per each eye, each frame, which may be twice as much as the Inset TFR. In particular embodiments, the computing system may combine the left side of both eyes or the right side of both eyes into a single motion vector calculation. This approach may not require extra encoder sessions. However, this combined motion vector calculation may not provide a visual boost and may likely have a higher risk in terms of confusing the encoder or optical flow calculator. FIG. 4 illustrates an example of a combined motion vector calculation. A part of an image for the left eye corresponding to a frame may be rendered on a left eye buffer 1410. A part of an image for the right eye corresponding to the frame may be rendered on a right eye buffer 1420. As the rendered part of both images comprises left side of the images, the computing system may combine left half of the both images and compute the motion vectors on the combined image on an encoder 1430 or an optical flow calculator. An area 1401 of the combined image may experience poor motion vector quality as parts from the both eye buffers are combined in the area 1401. However, the area 1401 may always be underneath the full-frame rate region of slice-based TFR. Although this disclosure describes calculating motion vectors by combining a part of images for both eyes in a particular manner, this disclosure contemplates calculating motion vectors by combining a part of images for both eyes in any suitable manner.

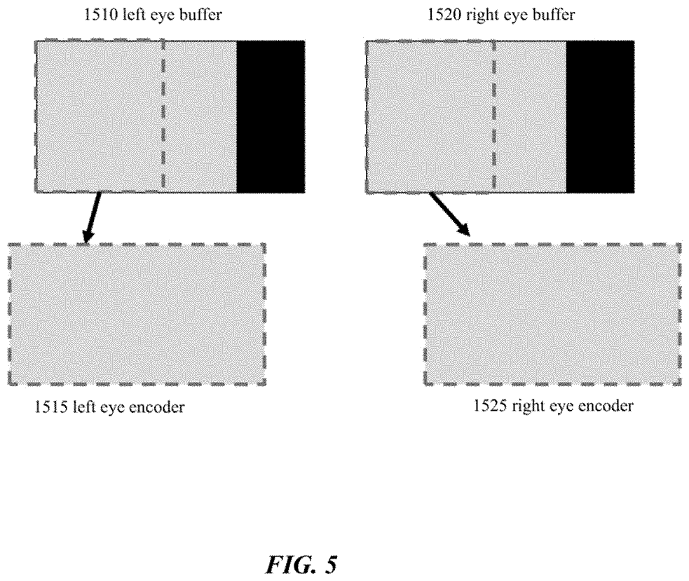

In particular embodiments, the computing system may separate motion vector calculations for each side of each eye. This separated motion vector calculation may provide higher fidelity horizontal translation. FIG. 5 illustrates an example of separated motion vector calculations. A part of an image for the left eye corresponding to a frame may be rendered on a left eye buffer 1510. A left half of the image for the left eye may be provided to a left eye encoder 1515 for a motion vector calculation purpose. A part of an image for the right eye corresponding to the frame may be rendered on a right eye buffer 1520. A left half of the image for the right eye may be provided to a right eye encoder 1525 for a motion vector calculation purpose. With the side of the eye being expanded to a larger horizontal region, a higher density of horizontal motion vectors may be expected. Although this disclosure describes performing separate motion vector calculations for each eye in a particular manner, this disclosure contemplates performing separate motion vector calculations for each eye in any suitable manner.

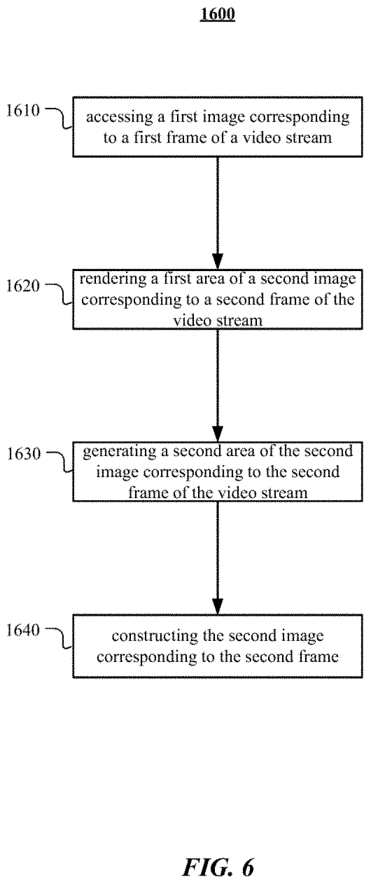

FIG. 6 illustrates an example method 1600 for rendering a slice of a frame and filling the rest of the frame with reprojections from previous frames. The method may begin at step 1610, where the computing system may access a first image corresponding to a first frame of a video stream. At step 1620, the computing system may render a first area of a second image corresponding to a second frame of the video stream. The second frame may be subsequent to the first frame. The first area may be an incomplete part of the second image. At step 1630, the computing system may generate a second area of the second image corresponding to the second frame of the video stream by re-projecting the second area of the first image according to one or more warping parameters. The second area may be rest of the first area in the images. At step 1640, the computing system may construct the second image corresponding to the second frame by compositing the rendered first area and the generated second area of the second image. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for rendering a slice of a frame and filling the rest of the frame with reprojections from previous frames including the particular steps of the method of FIG. 6, this disclosure contemplates any suitable method for rendering a slice of a frame and filling the rest of the frame with reprojections from previous frames including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Interaction with computing systems are often founded on a set of core concepts that define how users can interact with that computing system. For example, early operating systems provided textual interfaces to interact with a file directory. This was later built upon with the addition of “windowing” systems whereby levels in the file directory and executing applications were displayed in multiple windows, each allocated a portion of a 2D display that was populated with content selected for that window (e.g., all the files from the same level in the directory, a graphical user interface generated by an application, menus or controls for the operating system, etc.). As computing form factors decreased in size and added integrated hardware capabilities (e.g., cameras, GPS, wireless antennas, etc.) the core concepts again evolved, moving to an “app” focus where each app encapsulated a capability of the computing system.

Existing artificial reality (XR) systems provide models, such as 3D virtual objects and 2D panels, with which a user can interact in 3D space. Existing XR systems have generally backed these models by extending the app core computing concept. For example, a user can instantiate these models by activating an app and telling the app to create the model, and using the model as an interface back to the app. This approach generally requires simulating the types of interactions traditionally performed with mobile devices in the virtual space. This approach also generally requires continued execution of the app for the models to persist in the artificial reality environment. This in turn means that data sharing between applications require the apps sending and receiving the data to be running, which leads to power inefficiencies.

Aspects of the present disclosure are directed to an artificial reality system that is configured to facilitate data sharing between applications. Data may be encapsulated as an “augment,” which is a virtual object with a 2D or 3D volume in an artificial reality environment that can include presentation data, context, and logic. In some implementations, an artificial reality system can use augments as the fundamental building block for displaying 2D and 3D content in the artificial reality environment. For example, augments can represent people, places, and things in an artificial reality environment and can respond to a context such as a current display mode, date or time of day, a type of surface the augment is on, a relationship to other augments, etc. In some cases, an augment can correspond to a real-world object. For example, a screen augment can be a virtual object corresponding to a television. Augments can live on “surfaces” with context properties and layouts that cause the augments to be presented or act in different ways. A controlling application for the artificial reality system, sometimes referred to as a “shell,” can control how artificial reality environment information is surfaced to users, what interactions can be performed, and what interactions are provided to applications. Augments and other objects (real or virtual) can also interact with each other, where these interactions can be mediated by the shell and are controlled by rules in the augments, evaluated based on contextual information from the shell. Additional details on augment creation and surfaces are provided in U.S. patent application Ser. No. 17/2008,2478, filed Aug. 31, 22020, which is herein incorporated by reference in its entirety.

An augment may encapsulate data from an application running on the artificial reality device. For example, an email may be extracted from the email application and put into an augment, which is then managed by the operating system of the artificial reality device. As an augment, the photo may be manipulated according to the rules and logic of the operating system, including being shared. Sharing may occur, for example, when a user holds onto the augment and moves it onto a target virtual surface, such as a display panel on the wall showing a social-media newsfeed, a space on a table where a collection of augments are kept and organized, or an avatar of a friend. Each of the virtual surface may be associated with a different application (e.g., social-media application, an organization application, or a virtual calling/messaging application). By moving the augment to a target surface, the user may be providing an instruction to share the data associated with the augment with the application associated with the target surface. For example, by moving the email augment to the display panel showing a social-media newsfeed, a photo attached to the email may be consumed by the social-media application and uploaded to the social-media server. As another example, by moving the email augment to the table top associate with an organization application, the organization application may extract the sender's email address, search through the user's contact list to find a record of the email address, retrieve an avatar associated with the record, and display the avatar on the table top to show that an email was received from that person.

There are several challenges that need to be overcome in order to enable the aforementioned seamless sharing process. Virtual content, or objects, often contain vast amounts of data and a variety of information. Some of this information significantly increases the usefulness of the content to particular applications, and ultimately, to the user. However, not all of the information is relevant to every application, and extraneous information can cause problems related to significant amounts of data transfer such as latency in the running of an application. Also, in some instances, it may be desirable to share only a portion of the information for privacy reasons or to maintain control over possible subsequent transfers of the information. Thus, it is not desirable to copy data for each application with which the data is shared. Another issue is that applications often do not support the same data format. For example, an email application and a social-media application would be configured differently in terms of how they export and consume data.

This disclosure provides a solution to the aforementioned problems by utilizing an operating system to store the full set of data related to an object in a shared memory and granting access to individual applications so that they can select the portions of the information that are necessary to run the application. In addition, this method may improve the privacy and increase the control that a creator has over their content. This is possible because the disclosed method does not transfer full files between applications. Rather, it grants access to particular aspects of the content or subsets of the data, which access can be revoked by the creator since the full content remains under the control of the operating system itself.

In an embodiment, one or more applications may be installed on an operating system. Each application may have content that can be shared. The content may have a variety of types of data associated with it. For example, a picture may have information regarding pixels, location the picture was taken, location where the picture is currently stored, subjects in the picture, owner of the picture, etc. In another example, contact information for a restaurant may include a phone number, an address, and a menu, among other pieces of data. In an embodiment, an object may be uploaded onto the operating system. As yet another example, an email may have a sender, a recipient, a subject, a timestamp, a body of the email, and attachments. Content from an application may be provided to the operating system, along with a set of metadata that describe the types of data contained therein. Metadata may be communicated to the operating system via, for example, structured data (e.g., JSON, XML) or an API or library provided by the operating system. The data may be normalized. The operating system may create an augment to represent the content and store the content in a shared memory that is accessible to any application to which the operating system grants access permission.

Access permission may be granted in a variety of ways. In some embodiments, when a share event is triggered (e.g., the user moving an augment onto a target surface associate with a second application), the operating system may store information to indicate that the application receiving the content has been granted permission to access the underlying data in the shared memory. For sensitive content (e.g., photos captured natively by the device's camera), the operating system may prompt the user to confirm that he/she intended to share the content with the application. In some embodiments, a second application which is running on the same operating system as a first application may send a request to retrieve an object stored from a shared memory. In an embodiment, the request may trigger a request to the first application asking permission to retrieve the object. In another embodiment, the request may cause the operating system to locate access permissions associated with the object and grant or deny permission in accordance with the located access permissions. In yet another embodiment, the first application may send the request to the operating system to deliver the object to the second application, which may be accepted manually or through permissions and/or privacy settings previously set by a user of the second application. The granted access may be to the whole content or a portion of it. In the latter case, the application receiving the shared content may inform the operating system which types of data it would accept. For example, if an augment contains a friend's post on a social-media application, the augment might contain a link to the post, an image, text, the person who created the post, a timestamp, etc. When the augment is shared with an application that organizes content, the application might only need information about the person who created the post to create an avatar for that person, along with the link and the image. If so, the permission granted to the application might be limited to those data types and not the rest. In other words, applications would be granted access on a need-to-know basis.

In some embodiments, in response to receiving a command to share an object, which may be obtained from a first application and stored in a shared memory on an operating system, the operating system may grant access to data associated with the object to the second application, subject to access permissions and/or privacy settings associated with the first and second applications. The second application may have specific subsets of data that it needs out of all the data associated with the object, which specific subset of data may be necessary to use the object. The second application may retrieve the specific subset of data from the shared memory on the operating system. In some embodiments, the operating system may move the object and the specific subset of data onto the second application. Because the stored data is structured, the second application with which the data is shared would be able to understand and process the data. This is possible even though the second application may not know which application generated the data nor the native format or type of the data.

As an example, in an embodiment, a user of a first application may wish to share a picture. For practical and/or privacy reasons, it may be desirable to not convey all of the data associated with the picture. In some instances, a receiving application may only be able to handle certain types of data. However, other applications may require certain types of data to be able to fully utilize the object. For example, while an application used to create a vacation scrapbook may benefit from location data associated with a photograph, such information may not have practical use for a picture used on a dating application. This variety of needs for types of data between different applications makes it valuable to store the object and the data associated with the object in one place while allowing applications access to the data necessary to use the object on the application, subject to access permissions and privacy settings. In an embodiment, the first or second application may be a social networking application. In an embodiment, the access permissions may be tied to a social graph, which social graph determines the degree of relation between users of the first and second applications.

As another example, in an embodiment, a user of a first application may wish to share contact information with a user of a second application. The contact information may be contained within an object labeled as a particular person. The object associated with the particular person may contain more information than contact information, such as photos. To the user sharing the data, the object may appear as a person's avatar. The object may be shared with an operating system, which may store the object containing the contact information in shared memory. Later, the user of the first application may wish to share the phone number with another application, which may or may not be associated with the first user. An application used for dialing the phone number may access the phone number but not other data associated with email address, physical address, relation to the first user, etc. The first application may send a command to the operating system to allow the second application, in this case an application for dialing a phone number, to access the contact information. The operating system may grant access to the portion of the shared memory that houses the object associated with the particular person. The second application may then retrieve the subset of data associated with the contact information that it needs to call a particular contact. The operating system may act as a gate keeper to prevent information being shared or received by either application without permission being given by the user of the applications. In another example, the user of the second application may wish to send an email to a person whose information is contained in an object which has previously been shared with an operating system and stored in shared memory. The user of the second application may drag the object associated with the person from the operating system into the “To:” section of an email within an email application. The email application may retrieve the email address of the person associated with the object and populate the appropriate field in the email.

In some embodiments, an operating system and/or application may present suggestions of devices and/or applications with which to share an object based on a social network. For example, a user of a first application who wishes to share an object may receive suggestions of who to share the object with based on information previously input by them to the social network. Suggestions may be based on a social graph. Additionally or in the alternative, privacy and permission settings may be associated with information found on the social network or based on the social graph. For example, a second application that has listed the first application as being associated with a friend may be set to automatically receive pictures when the operating system receives a command to share the pictures from the first application to the second application. In another example, a user of a first application may allow a second application that is associated with a friend to access a greater subset of data when the second application receives an object from the first application.

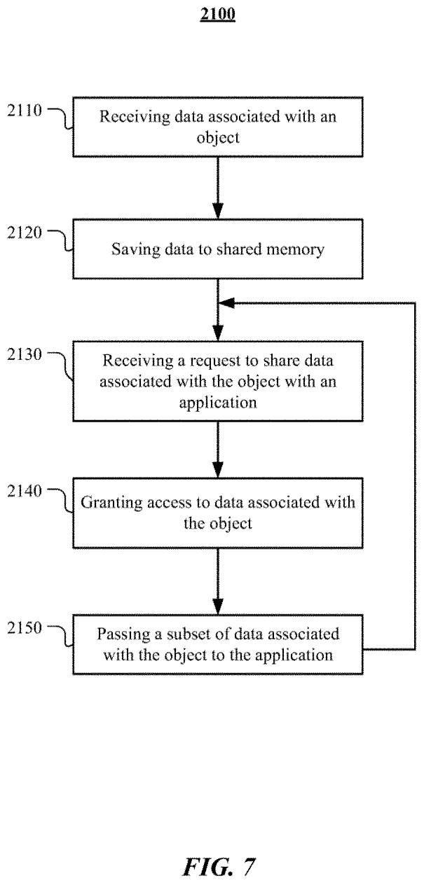

FIG. 7 illustrates an example method 2100 for sharing data between applications on an artificial-reality device. The method may begin at step 2110, where data associated with an object is received by an operating system. Prior to being received by the operating system, the data associated with the object may be housed in a first application. At step 2120, the data is saved to a shared memory within the operating system. At step 2130, the operating system receives a request to share data associated with the object with a second application. At step 2140, the operating system grants access to data associated with the object. At step 2150, the operating system passes a subset of data associated with the object to the second application. This may be in response a request from the second application to retrieve a particular subset of data from the data associated with the object. The particular subset of data may be types of data that are used for displaying or otherwise making use of the object within the second application. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for sharing data with an application including the particular steps of the method of FIG. 7, this disclosure contemplates any suitable method for sharing data with an application including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

### Systems and Methods

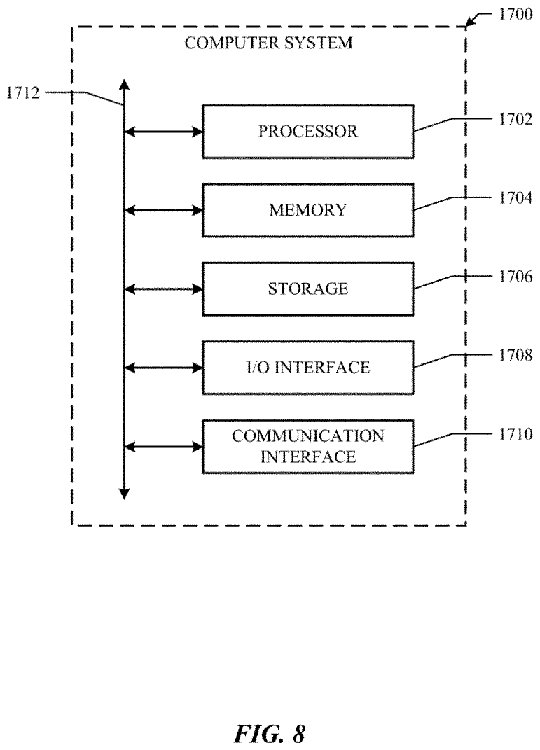

FIG. 8 illustrates an example computer system 1700. In particular embodiments, one or more computer systems 1700 perform one or more steps of one or more methods described or illustrated herein. In particular embodiments, one or more computer systems 1700 provide functionality described or illustrated herein. In particular embodiments, software running on one or more computer systems 1700 performs one or more steps of one or more methods described or illustrated herein or provides functionality described or illustrated herein. Particular embodiments include one or more portions of one or more computer systems 1700. Herein, reference to a computer system may encompass a computing device, and vice versa, where appropriate. Moreover, reference to a computer system may encompass one or more computer systems, where appropriate.

This disclosure contemplates any suitable number of computer systems 1700. This disclosure contemplates computer system 1700 taking any suitable physical form. As example and not by way of limitation, computer system 1700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1700 may include one or more computer systems 1700; be unitary or distributed; span multiple locations; span multiple machines; span multiple data centers; or reside in a cloud, which may include one or more cloud components in one or more networks. Where appropriate, one or more computer systems 1700 may perform without substantial spatial or temporal limitation one or more steps of one or more methods described or illustrated herein. As an example and not by way of limitation, one or more computer systems 1700 may perform in real time or in batch mode one or more steps of one or more methods described or illustrated herein. One or more computer systems 1700 may perform at different times or at different locations one or more steps of one or more methods described or illustrated herein, where appropriate.

In particular embodiments, computer system 1700 includes a processor 1702, memory 1704, storage 1706, an input/output (I/O) interface 1708, a communication interface 1710, and a bus 1712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1702 includes hardware for executing instructions, such as those making up a computer program. As an example and not by way of limitation, to execute instructions, processor 1702 may retrieve (or fetch) the instructions from an internal register, an internal cache, memory 1704, or storage 1706; decode and execute them; and then write one or more results to an internal register, an internal cache, memory 1704, or storage 1706. In particular embodiments, processor 1702 may include one or more internal caches for data, instructions, or addresses. This disclosure contemplates processor 1702 including any suitable number of any suitable internal caches, where appropriate. As an example and not by way of limitation, processor 1702 may include one or more instruction caches, one or more data caches, and one or more translation lookaside buffers (TLBs). Instructions in the instruction caches may be copies of instructions in memory 1704 or storage 1706, and the instruction caches may speed up retrieval of those instructions by processor 1702. Data in the data caches may be copies of data in memory 1704 or storage 1706 for instructions executing at processor 1702 to operate on; the results of previous instructions executed at processor 1702 for access by subsequent instructions executing at processor 1702 or for writing to memory 1704 or storage 1706; or other suitable data. The data caches may speed up read or write operations by processor 1702. The TLBs may speed up virtual-address translation for processor 1702. In particular embodiments, processor 1702 may include one or more internal registers for data, instructions, or addresses. This disclosure contemplates processor 1702 including any suitable number of any suitable internal registers, where appropriate. Where appropriate, processor 1702 may include one or more arithmetic logic units (ALUs); be a multi-core processor; or include one or more processors 1702. Although this disclosure describes and illustrates a particular processor, this disclosure contemplates any suitable processor.

In particular embodiments, memory 1704 includes main memory for storing instructions for processor 1702 to execute or data for processor 1702 to operate on. As an example and not by way of limitation, computer system 1700 may load instructions from storage 1706 or another source (such as, for example, another computer system 1700) to memory 1704. Processor 1702 may then load the instructions from memory 1704 to an internal register or internal cache. To execute the instructions, processor 1702 may retrieve the instructions from the internal register or internal cache and decode them. During or after execution of the instructions, processor 1702 may write one or more results (which may be intermediate or final results) to the internal register or internal cache. Processor 1702 may then write one or more of those results to memory 1704. In particular embodiments, processor 1702 executes only instructions in one or more internal registers or internal caches or in memory 1704 (as opposed to storage 1706 or elsewhere) and operates only on data in one or more internal registers or internal caches or in memory 1704 (as opposed to storage 1706 or elsewhere). One or more memory buses (which may each include an address bus and a data bus) may couple processor 1702 to memory 1704. Bus 1712 may include one or more memory buses, as described below. In particular embodiments, one or more memory management units (MMUs) reside between processor 1702 and memory 1704 and facilitate accesses to memory 1704 requested by processor 1702. In particular embodiments, memory 1704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1704 may include one or more memories 1704, where appropriate. Although this disclosure describes and illustrates particular memory, this disclosure contemplates any suitable memory.

In particular embodiments, storage 1706 includes mass storage for data or instructions. As an example and not by way of limitation, storage 1706 may include a hard disk drive (HDD), a floppy disk drive, flash memory, an optical disc, a magneto-optical disc, magnetic tape, or a Universal Serial Bus (USB) drive or a combination of two or more of these. Storage 1706 may include removable or non-removable (or fixed) media, where appropriate. Storage 1706 may be internal or external to computer system 1700, where appropriate. In particular embodiments, storage 1706 is non-volatile, solid-state memory. In particular embodiments, storage 1706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1706 taking any suitable physical form. Storage 1706 may include one or more storage control units facilitating communication between processor 1702 and storage 1706, where appropriate. Where appropriate, storage 1706 may include one or more storages 1706. Although this disclosure describes and illustrates particular storage, this disclosure contemplates any suitable storage.

In particular embodiments, I/O interface 1708 includes hardware, software, or both, providing one or more interfaces for communication between computer system 1700 and one or more I/O devices. Computer system 1700 may include one or more of these I/O devices, where appropriate. One or more of these I/O devices may enable communication between a person and computer system 1700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1708 for them. Where appropriate, I/O interface 1708 may include one or more device or software drivers enabling processor 1702 to drive one or more of these I/O devices. I/O interface 1708 may include one or more I/O interfaces 1708, where appropriate. Although this disclosure describes and illustrates a particular I/O interface, this disclosure contemplates any suitable I/O interface.

In particular embodiments, communication interface 1710 includes hardware, software, or both providing one or more interfaces for communication (such as, for example, packet-based communication) between computer system 1700 and one or more other computer systems 1700 or one or more networks. As an example and not by way of limitation, communication interface 1710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1710 for it. As an example and not by way of limitation, computer system 1700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1700 may include any suitable communication interface 1710 for any of these networks, where appropriate. Communication interface 1710 may include one or more communication interfaces 1710, where appropriate. Although this disclosure describes and illustrates a particular communication interface, this disclosure contemplates any suitable communication interface.

In particular embodiments, bus 1712 includes hardware, software, or both coupling components of computer system 1700 to each other. As an example and not by way of limitation, bus 1712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1712 may include one or more buses 1712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

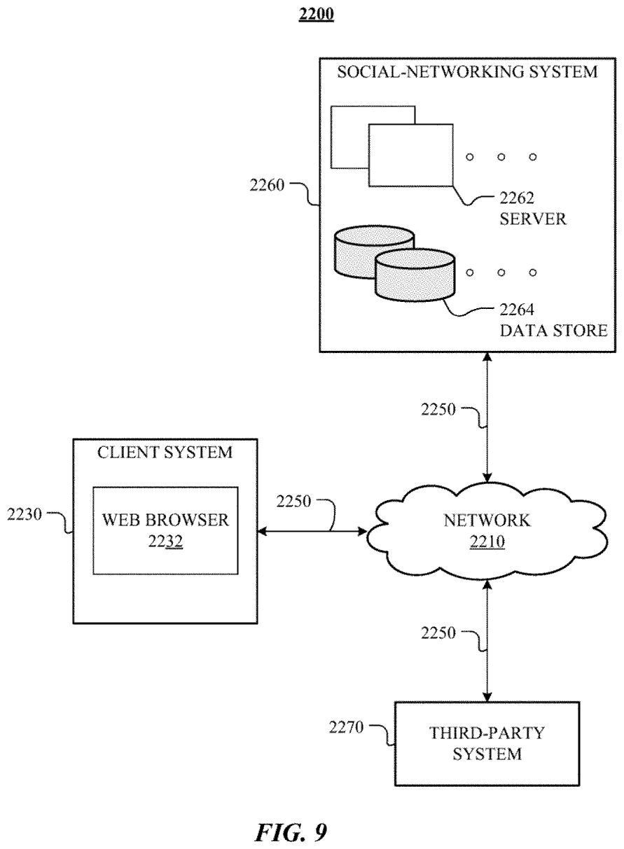

FIG. 9 illustrates an example network environment 2200 associated with a social-networking system. Network environment 2200 includes a client system 2230, a social-networking system 2260, and a third-party system 2270 connected to each other by a network 2210. Although FIG. 9 illustrates a particular arrangement of client system 2230, social-networking system 2260, third-party system 2270, and network 2210, this disclosure contemplates any suitable arrangement of client system 2230, social-networking system 2260, third-party system 2270, and network 2210. As an example and not by way of limitation, two or more of client system 2230, social-networking system 2260, and third-party system 2270 may be connected to each other directly, bypassing network 2210. As another example, two or more of client system 2230, social-networking system 2260, and third-party system 2270 may be physically or logically co-located with each other in whole or in part. Moreover, although FIG. 9 illustrates a particular number of client systems 2230, social-networking systems 2260, third-party systems 2270, and networks 2210, this disclosure contemplates any suitable number of client systems 2230, social-networking systems 2260, third-party systems 2270, and networks 2210. As an example and not by way of limitation, network environment 2200 may include multiple client system 2230, social-networking systems 2260, third-party systems 2270, and networks 2210.

This disclosure contemplates any suitable network 2210. As an example and not by way of limitation, one or more portions of network 2210 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 2210 may include one or more networks 2210.

Links 2250 may connect client system 2230, social-networking system 2260, and third-party system 2270 to communication network 2210 or to each other. This disclosure contemplates any suitable links 2250. In particular embodiments, one or more links 2250 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 2250 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 2250, or a combination of two or more such links 2250. Links 2250 need not necessarily be the same throughout network environment 2200. One or more first links 2250 may differ in one or more respects from one or more second links 2250.

In particular embodiments, client system 2230 may be an electronic device including hardware, software, or embedded logic components or a combination of two or more such components and capable of carrying out the appropriate functionalities implemented or supported by client system 2230. As an example and not by way of limitation, a client system 2230 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 2230. A client system 2230 may enable a network user at client system 2230 to access network 2210. A client system 2230 may enable its user to communicate with other users at other client systems 2230.

In particular embodiments, client system 2230 may include a web browser 2232, and may have one or more add-ons, plug-ins, or other extensions. A user at client system 2230 may enter a Uniform Resource Locator (URL) or other address directing the web browser 2232 to a particular server (such as server 2262, or a server associated with a third-party system 2270), and the web browser 2232 may generate a Hyper Text Transfer Protocol (HTTP) request and communicate the HTTP request to server. The server may accept the HTTP request and communicate to client system 2230 one or more Hyper Text Markup Language (HTML) files responsive to the HTTP request. Client system 2230 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 2260 may be a network-addressable computing system that can host an online social network. Social-networking system 2260 may generate, store, receive, and send social-networking data, such as, for example, user-profile data, concept-profile data, social-graph information, or other suitable data related to the online social network. Social-networking system 2260 may be accessed by the other components of network environment 2200 either directly or via network 2210. As an example and not by way of limitation, client system 2230 may access social-networking system 2260 using a web browser 2232, or a native application associated with social-networking system 2260 (e.g., a mobile social-networking application, a messaging application, another suitable application, or any combination thereof) either directly or via network 2210. In particular embodiments, social-networking system 2260 may include one or more servers 2262. Each server 2262 may be a unitary server or a distributed server spanning multiple computers or multiple datacenters. Servers 2262 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 2262 may include hardware, software, or embedded logic components or a combination of two or more such components for carrying out the appropriate functionalities implemented or supported by server 2262. In particular embodiments, social-networking system 2260 may include one or more data stores 2264. Data stores 2264 may be used to store various types of information. In particular embodiments, the information stored in data stores 2264 may be organized according to specific data structures. In particular embodiments, each data store 2264 may be a relational, columnar, correlation, or other suitable database. Although this disclosure describes or illustrates particular types of databases, this disclosure contemplates any suitable types of databases. Particular embodiments may provide interfaces that enable a client system 2230, a social-networking system 2260, or a third-party system 2270 to manage, retrieve, modify, add, or delete, the information stored in data store 2264.

In particular embodiments, social-networking system 2260 may store one or more social graphs in one or more data stores 2264. In particular embodiments, a social graph may include multiple nodes—which may include multiple user nodes (each corresponding to a particular user) or multiple concept nodes (each corresponding to a particular concept)—and multiple edges connecting the nodes. Social-networking system 2260 may provide users of the online social network the ability to communicate and interact with other users. In particular embodiments, users may join the online social network via social-networking system 2260 and then add connections (e.g., relationships) to a number of other users of social-networking system 2260 to whom they want to be connected. Herein, the term “friend” may refer to any other user of social-networking system 2260 with whom a user has formed a connection, association, or relationship via social-networking system 2260.

In particular embodiments, social-networking system 2260 may provide users with the ability to take actions on various types of items or objects, supported by social-networking system 2260. As an example and not by way of limitation, the items and objects may include groups or social networks to which users of social-networking system 2260 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 2260 or by an external system of third-party system 2270, which is separate from social-networking system 2260 and coupled to social-networking system 2260 via a network 2210.

In particular embodiments, social-networking system 2260 may be capable of linking a variety of entities. As an example and not by way of limitation, social-networking system 2260 may enable users to interact with each other as well as receive content from third-party systems 2270 or other entities, or to allow users to interact with these entities through an application programming interfaces (API) or other communication channels.

In particular embodiments, a third-party system 2270 may include one or more types of servers, one or more data stores, one or more interfaces, including but not limited to APIs, one or more web services, one or more content sources, one or more networks, or any other suitable components, e.g., that servers may communicate with. A third-party system 2270 may be operated by a different entity from an entity operating social-networking system 2260. In particular embodiments, however, social-networking system 2260 and third-party systems 2270 may operate in conjunction with each other to provide social-networking services to users of social-networking system 2260 or third-party systems 2270. In this sense, social-networking system 2260 may provide a platform, or backbone, which other systems, such as third-party systems 2270, may use to provide social-networking services and functionality to users across the Internet.

In particular embodiments, a third-party system 2270 may include a third-party content object provider. A third-party content object provider may include one or more sources of content objects, which may be communicated to a client system 2230. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 2260 also includes user-generated content objects, which may enhance a user's interactions with social-networking system 2260. User-generated content may include anything a user can add, upload, send, or “post” to social-networking system 2260. As an example and not by way of limitation, a user communicates posts to social-networking system 2260 from a client system 2230. Posts may include data such as status updates or other textual data, location information, photos, videos, links, music or other similar data or media. Content may also be added to social-networking system 2260 by a third-party through a “communication channel,” such as a newsfeed or stream.

In particular embodiments, social-networking system 2260 may include a variety of servers, sub-systems, programs, modules, logs, and data stores. In particular embodiments, social-networking system 2260 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 2260 may also include suitable components such as network interfaces, security mechanisms, load balancers, failover servers, management-and-network-operations consoles, other suitable components, or any suitable combination thereof. In particular embodiments, social-networking system 2260 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 2260 to one or more client systems 2230 or one or more third-party system 2270 via network 2210. The web server may include a mail server or other messaging functionality for receiving and routing messages between social-networking system 2260 and one or more client systems 2230. An API-request server may allow a third-party system 2270 to access information from social-networking system 2260 by calling one or more APIs. An action logger may be used to receive communications from a web server about a user's actions on or off social-networking system 2260. In conjunction with the action log, a third-party-content-object log may be maintained of user exposures to third-party-content objects. A notification controller may provide information regarding content objects to a client system 2230. Information may be pushed to a client system 2230 as notifications, or information may be pulled from client system 2230 responsive to a request received from client system 2230. Authorization servers may be used to enforce one or more privacy settings of the users of social-networking system 2260. A privacy setting of a user determines how particular information associated with a user can be shared. The authorization server may allow users to opt in to or opt out of having their actions logged by social-networking system 2260 or shared with other systems (e.g., third-party system 2270), such as, for example, by setting appropriate privacy settings. Third-party-content-object stores may be used to store content objects received from third parties, such as a third-party system 2270. Location stores may be used for storing location information received from client systems 2230 associated with users. Advertisement-pricing modules may combine social information, the current time, location information, or other suitable information to provide relevant advertisements, in the form of notifications, to a user.

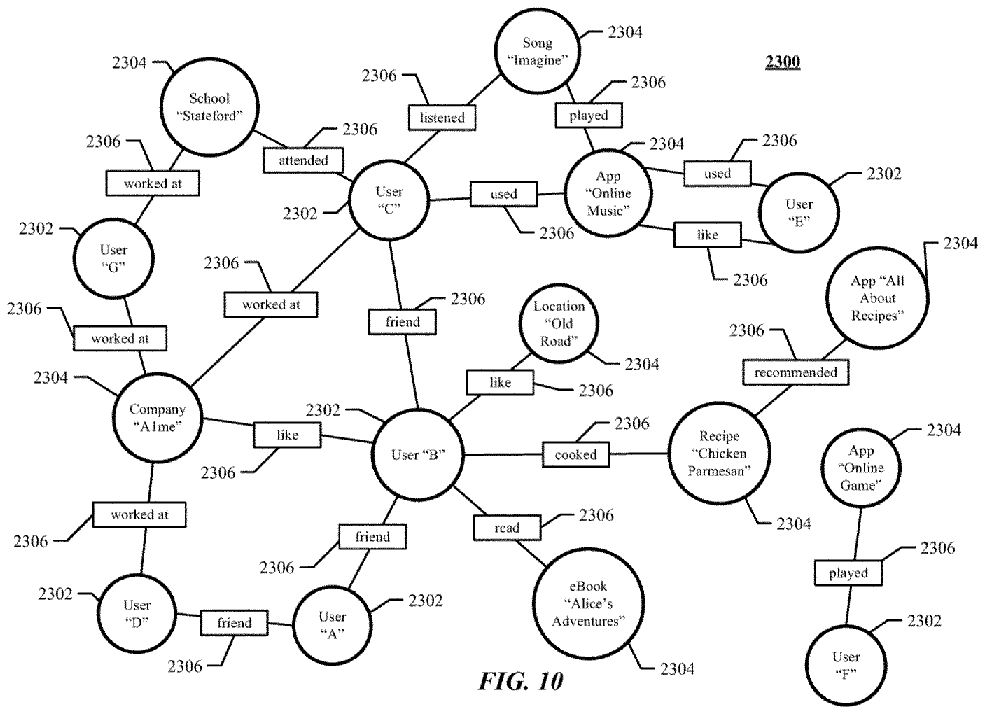

FIG. 10 illustrates example social graph 2300. In particular embodiments, social-networking system 2260 may store one or more social graphs 2300 in one or more data stores. In particular embodiments, social graph 2300 may include multiple nodes—which may include multiple user nodes 2302 or multiple concept nodes 2304—and multiple edges 2306 connecting the nodes. Each node may be associated with a unique entity (i.e., user or concept), each of which may have a unique identifier (ID), such as a unique number or username. Example social graph 2300 illustrated in FIG. 10 is shown, for didactic purposes, in a two-dimensional visual map representation. In particular embodiments, a social-networking system 2260, client system 2230, or third-party system 2270 may access social graph 2300 and related social-graph information for suitable applications. The nodes and edges of social graph 2300 may be stored as data objects, for example, in a data store (such as a social-graph database). Such a data store may include one or more searchable or queryable indexes of nodes or edges of social graph 2300.

In particular embodiments, a user node 2302 may correspond to a user of social-networking system 2260. As an example and not by way of limitation, a user may be an individual (human user), an entity (e.g., an enterprise, business, or third-party application), or a group (e.g., of individuals or entities) that interacts or communicates with or over social-networking system 2260. In particular embodiments, when a user registers for an account with social-networking system 2260, social-networking system 2260 may create a user node 2302 corresponding to the user, and store the user node 2302 in one or more data stores. Users and user nodes 2302 described herein may, where appropriate, refer to registered users and user nodes 2302 associated with registered users. In addition or as an alternative, users and user nodes 2302 described herein may, where appropriate, refer to users that have not registered with social-networking system 2260. In particular embodiments, a user node 2302 may be associated with information provided by a user or information gathered by various systems, including social-networking system 2260. As an example and not by way of limitation, a user may provide his or her name, profile picture, contact information, birth date, sex, marital status, family status, employment, education background, preferences, interests, or other demographic information. In particular embodiments, a user node 2302 may be associated with one or more data objects corresponding to information associated with a user. In particular embodiments, a user node 2302 may correspond to one or more webpages.

In particular embodiments, a concept node 2304 may correspond to a concept. As an example and not by way of limitation, a concept may correspond to a place (such as, for example, a movie theater, restaurant, landmark, or city); a website (such as, for example, a website associated with social-network system 2260 or a third-party website associated with a web-application server); an entity (such as, for example, a person, business, group, sports team, or celebrity); a resource (such as, for example, an audio file, video file, digital photo, text file, structured document, or application) which may be located within social-networking system 2260 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 2304 may be associated with information of a concept provided by a user or information gathered by various systems, including social-networking system 2260. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 2304 may be associated with one or more data objects corresponding to information associated with concept node 2304. In particular embodiments, a concept node 2304 may correspond to one or more webpages.

In particular embodiments, a node in social graph 2300 may represent or be represented by a webpage (which may be referred to as a “profile page”). Profile pages may be hosted by or accessible to social-networking system 2260. Profile pages may also be hosted on third-party websites associated with a third-party system 2270. As an example and not by way of limitation, a profile page corresponding to a particular external webpage may be the particular external webpage and the profile page may correspond to a particular concept node 2304. Profile pages may be viewable by all or a selected subset of other users. As an example and not by way of limitation, a user node 2302 may have a corresponding user-profile page in which the corresponding user may add content, make declarations, or otherwise express himself or herself. As another example and not by way of limitation, a concept node 2304 may have a corresponding concept-profile page in which one or more users may add content, make declarations, or express themselves, particularly in relation to the concept corresponding to concept node 2304.

In particular embodiments, a concept node 2304 may represent a third-party webpage or resource hosted by a third-party system 2270. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 2230 to send to social-networking system 2260 a message indicating the user's action. In response to the message, social-networking system 2260 may create an edge (e.g., a check-in-type edge) between a user node 2302 corresponding to the user and a concept node 2304 corresponding to the third-party webpage or resource and store edge 2306 in one or more data stores.

In particular embodiments, a pair of nodes in social graph 2300 may be connected to each other by one or more edges 2306. An edge 2306 connecting a pair of nodes may represent a relationship between the pair of nodes. In particular embodiments, an edge 2306 may include or represent one or more data objects or attributes corresponding to the relationship between a pair of nodes. As an example and not by way of limitation, a first user may indicate that a second user is a “friend” of the first user. In response to this indication, social-networking system 2260 may send a “friend request” to the second user. If the second user confirms the “friend request,” social-networking system 2260 may create an edge 2306 connecting the first user's user node 2302 to the second user's user node 2302 in social graph 2300 and store edge 2306 as social-graph information in one or more of data stores 2264. In the example of FIG. 10, social graph 2300 includes an edge 2306 indicating a friend relation between user nodes 2302 of user “A” and user “B” and an edge indicating a friend relation between user nodes 2302 of user “C” and user “B.” Although this disclosure describes or illustrates particular edges 2306 with particular attributes connecting particular user nodes 2302, this disclosure contemplates any suitable edges 2306 with any suitable attributes connecting user nodes 2302. As an example and not by way of limitation, an edge 2306 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 2300 by one or more edges 2306. The degree of separation between two objects represented by two nodes, respectively, is a count of edges in a shortest path connecting the two nodes in the social graph 2300. As an example and not by way of limitation, in the social graph 2300, the user node 2302 of user “C” is connected to the user node 2302 of user “A” via multiple paths including, for example, a first path directly passing through the user node 2302 of user “B,” a second path passing through the concept node 2304 of company “CompanyName” and the user node 2302 of user “D,” and a third path passing through the user nodes 2302 and concept nodes 2304 representing school “SchoolName,” user “G,” company “CompanyName,” and user “D.” User “C” and user “A” have a degree of separation of two because the shortest path connecting their corresponding nodes (i.e., the first path) includes two edges 2306.

In particular embodiments, an edge 2306 between a user node 2302 and a concept node 2304 may represent a particular action or activity performed by a user associated with user node 2302 toward a concept associated with a concept node 2304. As an example and not by way of limitation, as illustrated in FIG. 10, a user may “like,” “attended,” “played,” “listened,” “cooked,” “worked at,” or “watched” a concept, each of which may correspond to an edge type or subtype. A concept-profile page corresponding to a concept node 2304 may include, for example, a selectable “check in” icon (such as, for example, a clickable “check in” icon) or a selectable “add to favorites” icon. Similarly, after a user clicks these icons, social-networking system 2260 may create a “favorite” edge or a “check in” edge in response to a user's action corresponding to a respective action. As another example and not by way of limitation, a user (user “C”) may listen to a particular song (“SongName”) using a particular application (a third-party online music application). In this case, social-networking system 2260 may create a “listened” edge 2306 and a “used” edge (as illustrated in FIG. 10) between user nodes 2302 corresponding to the user and concept nodes 2304 corresponding to the song and application to indicate that the user listened to the song and used the application. Moreover, social-networking system 2260 may create a “played” edge 2306 (as illustrated in FIG. 10) between concept nodes 2304 corresponding to the song and the application to indicate that the particular song was played by the particular application. In this case, “played” edge 2306 corresponds to an action performed by an external application (the third-party online music application) on an external audio file (the song “SongName”). Although this disclosure describes particular edges 2306 with particular attributes connecting user nodes 2302 and concept nodes 2304, this disclosure contemplates any suitable edges 2306 with any suitable attributes connecting user nodes 2302 and concept nodes 2304. Moreover, although this disclosure describes edges between a user node 2302 and a concept node 2304 representing a single relationship, this disclosure contemplates edges between a user node 2302 and a concept node 2304 representing one or more relationships. As an example and not by way of limitation, an edge 2306 may represent both that a user likes and has used at a particular concept. Alternatively, another edge 2306 may represent each type of relationship (or multiples of a single relationship) between a user node 2302 and a concept node 2304 (as illustrated in FIG. 10 between user node 2302 for user “E” and concept node 2304 for “online music application”).

In particular embodiments, social-networking system 2260 may create an edge 2306 between a user node 2302 and a concept node 2304 in social graph 2300. As an example and not by way of limitation, a user viewing a concept-profile page (such as, for example, by using a web browser or a special-purpose application hosted by the user's client system 2230) may indicate that he or she likes the concept represented by the concept node 2304 by clicking or selecting a “Like” icon, which may cause the user's client system 2230 to send to social-networking system 2260 a message indicating the user's liking of the concept associated with the concept-profile page. In response to the message, social-networking system 2260 may create an edge 2306 between user node 2302 associated with the user and concept node 2304, as illustrated by “like” edge 2306 between the user and concept node 2304. In particular embodiments, social-networking system 2260 may store an edge 2306 in one or more data stores. In particular embodiments, an edge 2306 may be automatically formed by social-networking system 2260 in response to a particular user action. As an example and not by way of limitation, if a first user uploads a picture, watches a movie, or listens to a song, an edge 2306 may be formed between user node 2302 corresponding to the first user and concept nodes 2304 corresponding to those concepts. Although this disclosure describes forming particular edges 2306 in particular manners, this disclosure contemplates forming any suitable edges 2306 in any suitable manner.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

What is claimed is:

1. A method comprising, by a computing system:
accessing a first image corresponding to a first frame of a video stream;
rendering a first area of a second image corresponding to a second frame of the video stream, wherein the second frame is subsequent to the first frame, wherein the first area is an incomplete part of the second image;
generating a second area of the second image corresponding to the second frame of the video stream by re-projecting the second area of the first image according to one or more warping parameters, wherein the second area is rest of the first area in the images; and
constructing the second image corresponding to the second frame by compositing the rendered first area and the generated second area of the second image.

2. A method for sharing data with an application, comprising:
receiving, by an operating system, a set of data associated with an object from a first application running on the operating system, the set of data encapsulating information specifying types of data in the set of data;
storing, by the operating system, the set of data associated with the object in a shared memory;
receiving, by the operating system, a command to share the object with a second application running on the operating system;
providing, by the operating system, the second application access to the shared memory where the set of data is stored, wherein the information specifying the types of data in the set of data is configured to be used by the second application to retrieve a desired subset of the set of data.
